(19) United States
(12) Patent Application Publication
(10) Pub. No.: US 2007/0040466 A1
(43) Pub. Date: Feb. 22, 2007

(54) Electric machine with an induction rotor

(76) Inventor: Rolf Vollmer, Gersfeld (DE)

Correspondence Address: HENRY M FEIEREISEN, LLC, 350 FIFTH AVENUE, SUITE 4714, NEW YORK, NY, 10118, US

(21) Appl. No.: 10/572,022

(22) PCT Filed: Sep. 11, 2003
(86) PCT No.: PCT/DE03/03021

§ 371 Date: Mar. 13, 2006

(51) Int. Cl. H02K 21/12; H02K 1/00; H02K 17/00

(52) U.S. Cl. 310/212; 310/180; 310/216; 310/156.81

(57) ABSTRACT

To attenuate the parasitic air-gap fields of an electric machine, various measures are carried out on the stator (3) and/or rotor (7).

The invention relates to an electrical machine having a stator with a winding system and a rotor.

In conventional windings in electrical machines, discrepancies from the sinusoidal shape occur in the airgap field, that is to say harmonics are superimposed on the fundamental and have a disturbing effect on the operation of the electrical machine, for example in the form of additional losses. Windings are provided with short pitches in order to reduce the harmonic losses. In this case, windings are used with hole numbers of q>1, for example q=2 or q=3, which reduce the harmonics.

Windings with tooth-wound coils, that is to say concentrated windings around a mechanical pole, result in a comparatively considerably greater spectrum of airgap fields which cannot be reduced by the methods mentioned above, because of the characteristics of the tooth-wound coil technology. Particularly when using windings with tooth-wound coils in asynchronous motors, this leads to disturbances in the operating behavior.

The invention is accordingly based on the object of providing an electrical machine in which only one predeterminable spectrum of airgap fields induces a voltage in rotor conductors.

The stated object is achieved by an electrical machine as claimed in claim 1.

Windings with tooth-wound coils whose number of basic pole pairs on the stator is equal to the number of useful pole pairs p_{N} have low winding factors for the number of useful pole pairs and excessively high winding factors for unused numbers of pole pairs, and are therefore not to be preferred. A tooth-wound coil arrangement is therefore proposed which has a comparatively high winding factor for the number of useful pole pairs p_{N} and, furthermore, filters out disturbing numbers of pole pairs.

The stator design advantageously has a fractional tooth pitch in this case. In this case, considered in the circumferential direction of the stator, different, preferably two tooth-pitch widths alternate, with only the teeth with the greater tooth-pitch width being provided with in each case at least one tooth-wound coil. A fractional tooth pitch of the stator allows a reduced parasitic spectrum, so that the airgap fields now also have only a specific predeterminable proportion of the respective overall spectrum.

In order to obtain further damping of disturbing pole numbers of the airgap field, the rotor and/or the stator are/is additionally inclined, that is to say the slots do not run exactly axially, but at an inclination angle which can be predetermined. The value of the inclination angle depends on the numbers of poles to be damped.

Furthermore, the conductors of the rotor are connected according to the invention to form conductor loops such that the number of useful pole pairs p_{N} represents the number of basic pole pairs p_{GR} of the conductor loops of the rotor. q is preferably chosen to be equal to one for the hole number of the conductor loops of the rotor. The number of slots filled with conductor loops is in this case an integer multiple of twice the number of useful pole pairs.

In order in addition to also reduce reluctance oscillating torques, additional slots are advantageously provided specifically in the sheet metal of the rotor and are not filled with conductor loops.

The conductor loops of the rotor have at least two isolated branches, preferably comprising aluminum bars, copper bars, copper windings or braided wires.

The invention as well as further advantageous refinements of the invention will be explained in more detail with reference to schematically illustrated exemplary embodiments. In the figures:

FIG. 1 shows a sketch of a winding of a rotor, illustrated in the form of an envelope development,

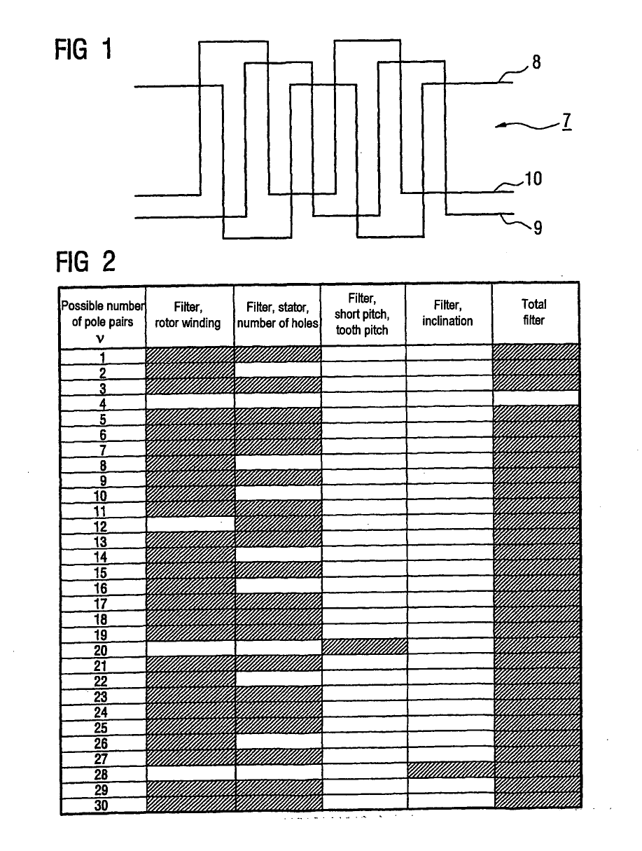

FIG. 2 shows the filter effects, illustrated in tabular form,

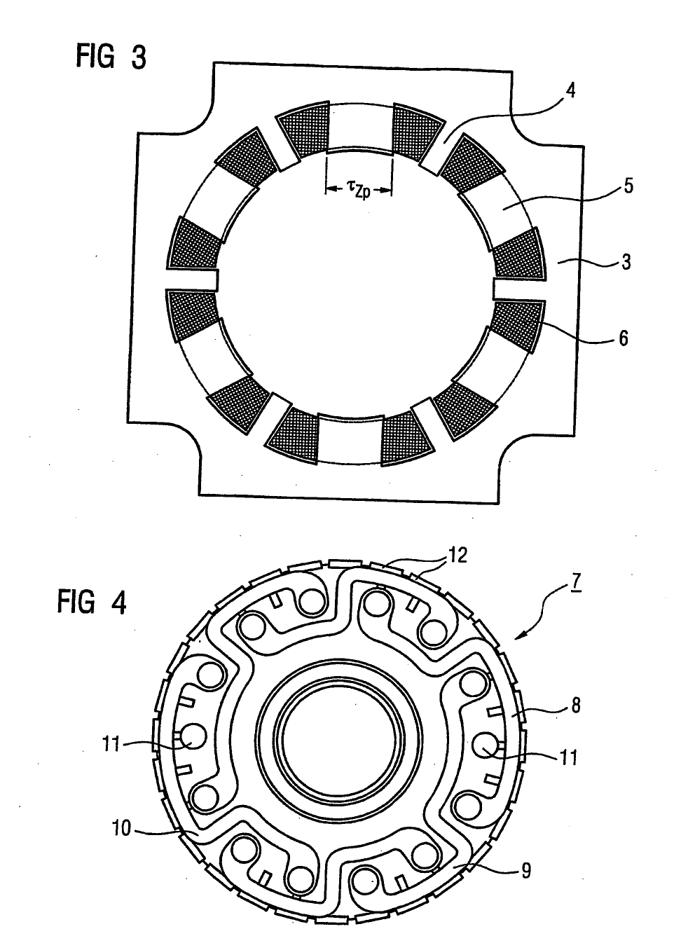

FIG. 3 shows the fractional tooth pitch of an asynchronous motor whose number of useful poles is 2p=8,

FIG. 4 to FIG. 6 show various rotor embodiments,

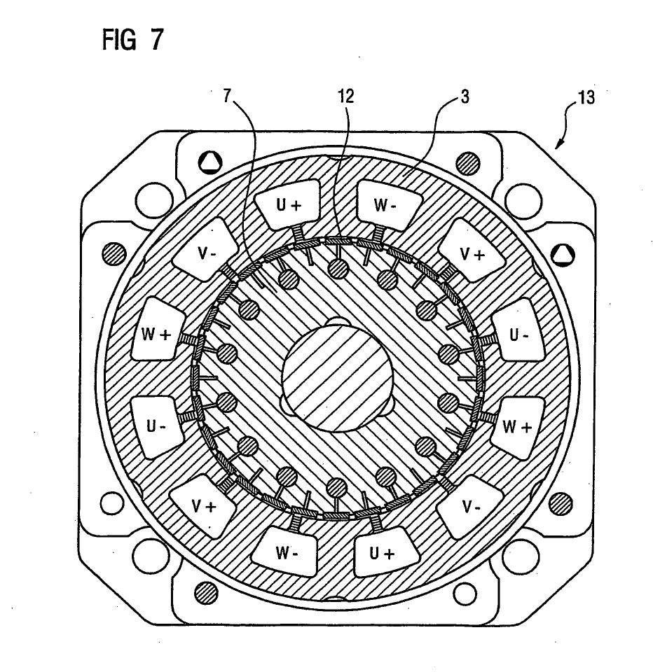

FIG. 7 shows an electrical machine with a conventional winding, and

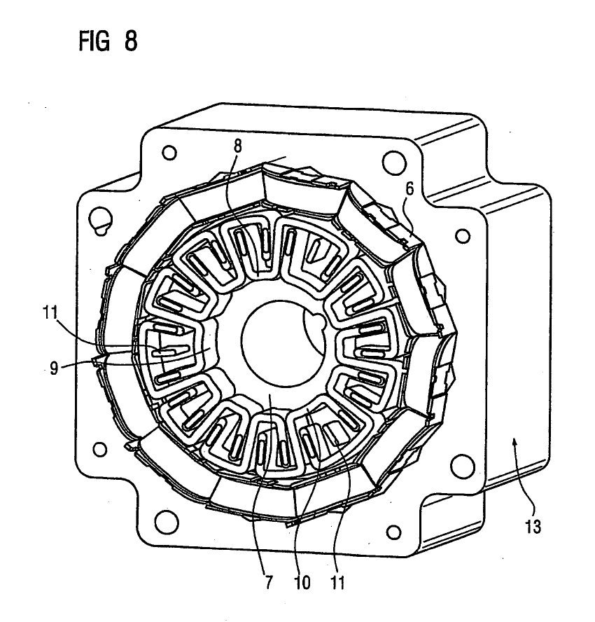

FIG.8 shows an electrical machine with a winding composed of tooth-wound coils.

FIG. 1 shows a schematic illustration, in the form of a envelope development, of a rotor 7, which is not illustrated in any more detail but has three squirrel-cage windings 8, 9, 10, which are electrically isolated from one another, with twelve slots and with the number of basic pole pairs being 2p_{GR}=4. A plurality of squirrel-cage windings, which are inductively isolated from one another, are also possible in or on a rotor 7. These squirrel-cage windings according to the invention are also referred to as conductor cages.

In the case of two squirrel-cage windings which are electrically isolated from one another, the second winding of the rotor 7 is phase-shifted through 180° electrical.

In general, the phase shift α_{P-P} of winding systems according to the invention, which have m winding sections, of a rotor 7 is given by:
α_{P-P}=360°/m

FIG. 1 also shows a system with three winding sections and with a phase shift of α_{P-P}=120°. The number of winding sections m may also be greater than 3. If m=3, this results in the electrical machine running comparatively smoothly. As the number of winding sections m increases, the production complexity for a winding system increases. A winding system in which m=3 thus represents a good compromise between production complexity and running quality. Additional predeterminable inclines of the rotor 7 and/or of the stator 3 in the region of x-times the slot pitch, where 0<x<2.6, improve the running and reduce losses since harmonics are damped.

FIG. 2 shows a list of the possible filter effects such as the winding of the rotor 7, the inclination of the stator 3 and rotor 7, fractional tooth pitch and winding on the stator 3 using tooth-wound coils, on the respective harmonics. In the illustrated range of pole numbers for a asynchronous machine with eight poles, the chosen measures result in only one airgap field in which p=4 leading to a torque.

The described invention is preferably suitable for asynchronous machines with a winding composed of tooth-wound coils, but is also suitable for synchronous machines with a fractional tooth pitch and with an additional induction rotor, in order to damp or to eliminate disturbing numbers of pole pairs.

In this case, the expression tooth-wound coil means concentrated coils which each have one mechanical pole or tooth 5, so that the forward and return conductors of the tooth-wound coil 6 are arranged in immediately adjacent slots in the tooth 5. The tooth-wound coils 6 may in this case preferable be provided in a prefabricated form.

The expression a fractional tooth pitch as shown in FIG. 3 means that teeth 4, 5 with different tooth-pitch widths alternate in the circumferential direction of the stator 3 of a three-phase machine, in which case only the teeth 5 with the greater tooth-pitch width τ_{zp} are preferably provided with tooth-wound coils 6. The tooth-pitch width τ_{zp} of the wound tooth 5 advantageously correspond to 0.66 to 1.0 times the pole pitch of a rotor, which is not illustrated in any more detail.

From the manufacturing point of view, it is advantageous to form the laminated section of a stator 3 such as this integrally.

FIG. 4 shows a rotor 7 with three conductor cages 8, 9, 10 which are conductively isolated from one another and in which the number of slots in the rotor 7 is N₂=14, and in which case contact is not made with two conductors 11. Permanent magnets 12 are located on the external circumference of the rotor 7 and are attached to the rotor 7, inter alia, by means of bindings or sleeves which are not illustrated in any more detail.

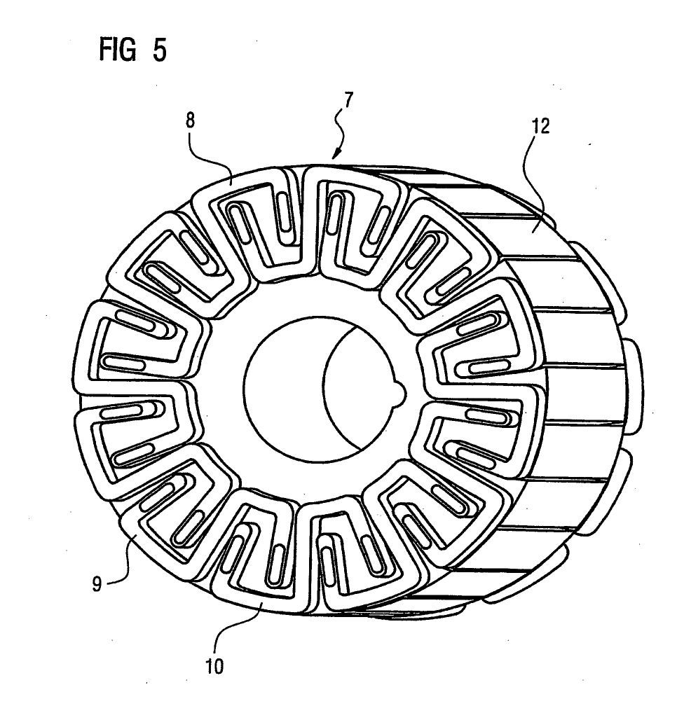

FIG. 5 shows a further rotor 7 in which the number of useful poles is 2p=8, and the number of slots is N₂=24. Once again, three conductor cages 8, 9, 10 are provided, and are conductively isolated from one another.

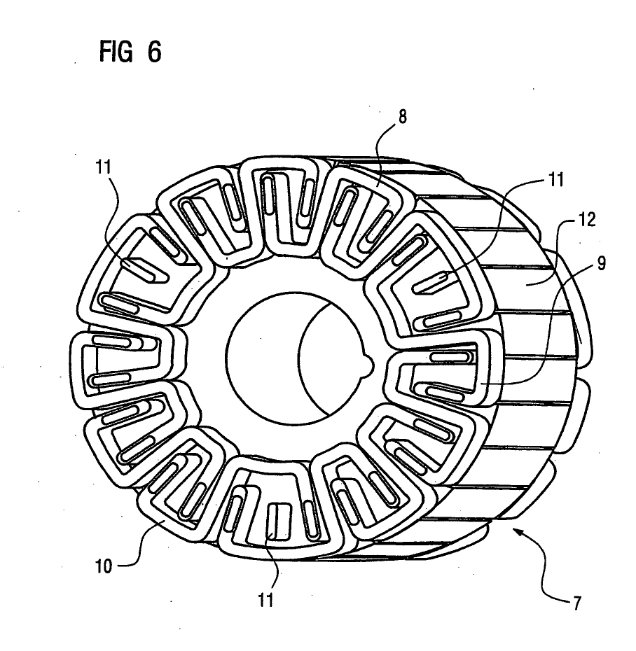

FIG. 6 shows a further rotor 7 in which the number of useful poles is 2p=8, and the number of slots N₂=27. Once again, three conductor cages 8, 9, 10 are provided, and are conductively isolated from one another. No contact is made with three slot conductors 11, and they arranged offset through 120 degrees, seen in the circumferential direction.

FIG. 7 shows an electrical synchronous machine 13 having a stator 3 which has a conventional winding system, that is to say it has short-pitch windings. A rotor 7 as shown in FIG. 4, for example, is inserted into the stator bore.

FIG. 8 shows a stator 3 of an asynchronous motor with twelve tooth-wound coils 6. The rotor 7 has N₂=27 slots, with no electrical contact being made with three slot conductors 11. Three squirrel-cage windings, also referred to as conductor cages 8, 9, 10, are provided, and are conductively isolated from one another. By way of example, this rotor 7 has no permanent magnets.

The electrical machine according to the invention is particularly suitable for production machines, for example machine tools, but is just as suitable for drives for electrical vehicles.

1. An electrical machine, having a stator (3) with a winding system (6) and a rotor (7), with the stator (3) and/or the rotor (7) having means to damp or to eliminate airgap fields which can be predetermined.

2. The electrical machine as claimed in claim 1, characterized in that the stator (3) has a fractional tooth pitch.

3. The electrical machine as claimed in claim 1 or 2, characterized in that the rotor (7) has at least two squirrel cages (8, 9) which are electrically isolated from one another.

4. The electrical machine as claimed in claim 3, characterized in that the squirrel cages (8, 9, 10) of the rotor (7) are offset through 360°/n electrical, where n is the number of isolated squirrel cages (8, 9, 10).

5. The electrical machine as claimed in one of the preceding claims, characterized in that the slots in the stator (3) and/or rotor (7) have additional inclinations which can be predetermined.

6. The electrical machine as claimed in one of the preceding claims, characterized in that the rotor (7) has slots N₂ which do not contain any conductors or whose conductors (11) are not connected to the squirrel cages (8, 9, 10).

7. The use of an electrical machine as claimed in one or more of the preceding claims for production machines or drives for electric vehicles.
